(19) United States
(12) Patent Application Publication
(10) Pub. No.: US 2011/0282742 A1
(43) Pub. Date: Nov. 17, 2011

(54) Advertisement Displaying Browser and Advertisement System

(75) Inventor: Shigeto Umeda, Tokyo (JP)

(73) Assignee: NUTEX INC., Tokyo (JP)

(21) Appl. No.: 12/913,138

(22) Filed: Oct. 27, 2010

(30) Foreign Application Priority Data
May 14, 2010 (JP) 2010-112114
Jul. 27, 2010 (JP) 2010-168467
Oct. 16, 2010 (JP) 2010-233148

(51) Int. Cl. G06Q 30/00; G06F 17/00

(52) U.S. Cl. 705/14.54; 715/201; 705/14.53

(57) ABSTRACT

An internet browser equipped in itself with a function to obtain and display video advertisement data along with an advertisement system that is connected to one or more advertisement data storing websites located on a communication network and the communication network itself, includes the user terminal equipped with the browser as described in embodiment 1, and displays to the user data obtained from the browser, according to the advertise management function. The browser is equipped with social functions, and is a system where the user can receive a reward for browsing advertisements.

### CROSS-REFERENCE TO RELATED APPLICATIONS

The present application claims the benefit of Paris Convention priority from Japanese Patent Application No. 2010-112114 filed May 14, 2010; Japanese Patent Application No. 2010-168467, filed Jul. 27, 2010; and Japanese Patent Application No. 2010-233148, filed Oct. 16, 2010, the contents of which are incorporated herein by reference in their entirety.

### FIELD OF THE INVENTION

The present invention relates to an internet browser equipped with an advertisement data acquiring and display function (also referred to as “web browser” hereinafter) along with the advertisement system that uses the same, specifically a socialized advertisement display browser and an advertisement system that uses the same. In this invention, the term “browser” refers to the tool used when connecting to the internet on an operating system (OS).

### BACKGROUND OF THE INVENTION

In recent years, the internet advertisement market has been growing at a rapid speed, and currently composes about 10% of the entire advertisement market, with further potential for growth. In comparison to the mass media, it has consolidated its position as the third largest medium after the television and newspapers.

These internet advertisements are composed of banner advertisements, listing advertisements electronic mail advertisements, etc. Among these, banner advertisements are banners composed of pictures, animations etc. and published on websites, and when clicked, jump to the sponsor's (e.g. Companies') website or products. Listing advertisements display advertisements at a position that can be readily seen by the individual searching on famous search engines. In email advertisements, text or html files are sent to those who are registered for the article information distribution service. Normally, for any of these, by clicking on the advertisement unit, one can jump to the home page of the sponsor (for example, Patent Document 1(Japanese Patent Laid-Open Publication No. 2002-297993)).

Yet, the abovementioned conventional internet advertisements are restricted to jumps from banners to sponsors' websites or popup functions that open separate windows, and are concluded by the user's action and the transition to the sponsor website. Therefore, in order to reach the advertisement target layers, various endeavors such as placing banner advertisements on multiple websites, relating the advertisements to search keywords (abovementioned listing advertisements), collecting email addresses from the demand layer, etc.

Under these circumstances, push advertisements have been suggested as a more active way of demonstrating advertisement effects. In push advertisements, dedicated software will be used so that when the user downloads advertisement data from the web, delivery will be conducted simultaneously. For example, in Patent Document 2 (Japanese Patent Laid-Open Publication No. 2001-118006), a technology is described in which by showing the advertisement content on the entire web browser or part of the web browser rather than allotting advertisement space on websites, it is possible to have the user concentrate on the advertisement and improve advertisement effects.

Furthermore, a technology is described in which the advertisements are distributed so as to match the area or field used often by the user and the area or field that the distributed advertisement belongs to, such as to distribute information-rich advertisements to users that can be expected to have stronger interest in the advertisement or to distribute advertisements with smaller quantities of information to users who are expected to have weaker interest in the advertisement. An example of this system is Google Inc.'s Adwords system, and the method is described in Patent Document 5 (Japanese Patent Laid-Open Publication No. 2001-500700).

Furthermore, in Patent Document 6 (Japanese Patent No. 3693938), a screensaver-type advertisement method using video distribution is proposed. Yet, as described in claim 1 “an information distribution system characterized by automatically obtaining and displaying the distribution information and ending the said information receiving program as soon as the said browser finishes displaying the said contents”, it is restricted to the system displaying the contents obtained in real time. Also, in the first sentence of claim 1, it says “according to the access to the before mentioned computer terminal, the information reception program or the content, including tags for information reception programs, will be sent out to the said computer terminal”, and therefore, in this patent, “the information receiving program or the content, including tags for information receiving programs” must be sent out every time there is an access.

As described above, under the circumstances in which the amount of time using the internet within daily life has increased dramatically and the use of mobile phones or personal computers has become almost synonymous to the use of the internet, the best mechanisms to use the characteristic of the internet as an interactive medium in association with a combination of existing technologies or technological elements had not been incorporated. The present invention can be used widely as internet advertisements, and aims to provide an effective and high quality advertisement information display system according to the internet user's lifestyle. Especially, in conventional systems, there was not much attraction for internet users to continue watching advertisements, and efficiency was low both for the sponsor side and the internet user side.

The present inventor, with zealous consideration of the solutions for the abovementioned issues, found that a browser that is in itself able to obtain and display video advertisement data is an effective advertisement media measure, and came to this invention. Furthermore, the abovementioned browser will be socialized and through distributing points for watching the advertisement, there would be an incentive to continue watching the advertisement. The sponsor would be able to distribute advertisements specialized for the demand group, and the efficiency would increase dramatically.

Regarding the advertisement space assessment, account management and charging systems, advertisement marketplaces such as Yahoo (Overture), Adwords, etc are known. These services are basically mechanisms in which links from sponsors who bid the highest are displayed at a higher position. On the other hand, the present invention is a system (business model) in which videos from the sponsor who bid the highest are prioritized, distributed to the target users, and at the same time, the target users are able to receive a portion of the advertisement fees, and are clearly distinct from links, clicks, text advertisements, etc. in terms of the way of submitting the advertisement, size of advertisement, files, etc. Compared to conventional internet advertisements such as text advertisements, video advertisements (commercials, etc) are a larger burden for the users and therefore, and through combination with returning part of the profit to the users, the present invention has succeeded in designing a business model that would make video advertisement realistic.

In other words, the advertisement marketplace attracts users by providing search engine services for free, but advertisements are only displayed statically. On the other hand, this invention surpasses the “free (browser use for free)” scheme and proposes a profit “return” scheme as the attraction to video advertisement distribution. By surpassing the “free” scheme, the present invention provides incentive for users to accept video advertisements, which take users' time and space.

The feasibility of the scheme can be assessed by comparing with the present television and internet advertisement value and approximate length of time that users watch the television or internet. Furthermore, it can be said that the present invention is essential for the survival of the declining top media and television advertisements (commercials, etc).

Conventionally, when watching certain websites with internet browsers, advertisements can be displayed using html files, flash files, etc. video websites using streaming technology also exist. But, although these display advertisements on the browsers, the browser in itself does not have the function to obtain and display video advertisement data. On the other hand, the present invention equips the browser in itself with these functions, and is based on an entirely different concept.

### SUMMARY OF THE INVENTION

The present invention includes the following internet browser and advertisement system:

[1] An internet browser equipped in itself with a function to obtain and display video advertisement data.

[2] An internet browser comprising an internet browser program to which base an advertisement obtaining function and/or advertisement display function is/are appended.

[3] The internet browser according to the above 1 or 2 further equipped with social functions.

[4] The internet browser according to any of the above 1-3, further equipped with an advertisement management function, wherein the advertisement management function can save and/or analyze users' browsing history and/or searching history, select recommended advertisements according to these results, transmit to the advertisement obtaining function, and the advertisement obtaining function can obtain advertisement data accordingly, and the advertisement display function can display the advertisement in either the advertisement display area or the entire screen.

[5] The internet browser according to any of the above 1-3 wherein the browser obtains data from a website equipped with an advertisement management function which can save and/or analyze users' browsing history and/or searching history, select recommended advertisements according to these results, and using or not using the advertisement management function of the browser, displays the advertisement in either the advertisement display area or the entire screen.

[6] An advertisement system that is connected to one or more advertisement data storing websites located on a communication network and the communication network itself, includes the user terminal equipped with the browser as described in embodiment 1, and displays to the user data obtained from the abovementioned browser, according to the abovementioned advertise management function.

[7] The advertisement system according to the above 6 comprising an advertisement data storing website equipped with an advertisement information database which includes advertisement data management file groups including advertisement file that describes the properties of the advertisement to be displayed and advertisement information actually displayed wherein the system sends to the browser the advertisements that the user can be considered to be interested in based on the data sent from the advertisement obtaining function of the browser.

[8] The advertisement system according to the above 6 and 7 wherein video advertisements from the advertisement data storing website are downloaded and saved in the user terminal and played according to requests to the controllers (including storage devices) from the browser.

[9] The advertisement system according to any of the above 6-8 in which an additional one or more management websites are further located on the communication network, and the abovementioned browser management function saves and/or analyzes the users' advertisement browsing data, and a reward is given to the user for watching the advertisement is given to the user according to the data or analyzed results sent to the management website.

[10] The advertisement system according to any of the above 6-8 further comprising one or more management websites located on the communication network, wherein the browser management function saves and/or analyzes the users' advertisement browsing data and/or searching history and transmit the data or analyzed results to the management website and a reward is given to the user for watching the advertisement according to the data or analyzed results.

[11] The advertisement system according to any of the above 6-10 in which the reward given to the user for watching an advertisement is related to the profile of the target layer and the profile of the user.

[12] The advertisement system according to any of the above 6-11 in which the advertisement space is purchased by advertisement providers through bidding.

When looking at the present invention from the sponsor side, the browser is a window to connect to the internet, and by transforming the browser into a media, it is possible to obtain a share of the advertisement market with active involvement from the entire spectrum of internet users. Looking from the user side, the possibility of being able to obtain necessary product information easily becomes higher, and it is also possible to have a portion of the profit from watching advertisements returned. In addition, the present invention includes a function in which the advertisement shown to the user is determined by the search keywords or clicked keywords from browser requests, but unlike conventional browsers which use cookie created by the browsed site, the present invention saves browsing history, etc in the browser itself, making it possible to browse with a high level of security.

Even today, the television continues to provide high quality contents in comparison to the internet, and the advertisements created by professionals are also of high quality. The present invention aims for the position as a “communicable monitor” just as computers and television are. In other words, the business model of this invention is to introduce high quality contents (i.e. television commercials) to the internet world through targeting in computer monitors in the current era of bilateral communication where the model of “average user” is meaningless.

### BRIEF DESCRIPTION OF THE DRAWINGS

FIG. 1 is a schematic view illustrating an example of the display screen according to the browser in the present invention.

FIG. 2 is a schematic view illustrating the flow of information for a single mode of use for the advertisement system of the present invention.

FIG. 3 is a schematic view illustrating the flow of information in a different mode of use for the advertisement system of the present invention.

### DETAILED DESCRIPTION OF THE INVENTION

Next, the details of the embodiments of the invention will be explained.

### Embodiment 1

According to the first embodiment of the present invention, the web browser is something that is operated on a computer and/or various dedicated terminals, equipped with the normal browser functions as well as an advertisement obtaining function and/or advertisement display function. Other than these functions, the basic composition of the browser can be the same as that of conventionally known web browsers, and for the basis, Chromium, for example, can be used. Chromium is the basis for “Google Chrome”, the browser developed by Google, and for the source code, BSD license is applied. For the html rendering engine, Webkit is applied just as it is for Safari, so it is possible to display while conforming to the web standards. Yet, the present invention is applicable to all other existing browsers as well as browsers that are to be developed in the future.

The advertisement obtaining function is a function in which advertisement data is obtained from a preset web server, and at a designated timing or when the user is using the internet, advertisement data is obtained based on the data accumulated by the advertisement management system, which will be explained later. Obtaining of the advertisement data will be performed in various general ways used to obtain information from specific websites. This is performed typically as the obtaining of html files or video data, and the latter can be either by streaming or by downloading. Of such methods, for protocols, control and script conventional methods are included, but in the future, every method that can be used to browse the web will be included. In the present invention, video advertisements are not limited to streaming videos, and include modes in which downloads take place and are played at each fixed timing. In this mode, patterns in which either regularly or every time the browser is activated, the necessary video files are downloaded or renewed on the computer side by accessing the internet, and displaying from there (explained in detail in Embodiment 2).

The advertisement obtaining function, in addition to the above, for example, can be equipped with a circuit speed measuring function or access limiting function. For example, by requesting the advertisement data storing website to send a file with a specified size to the user terminal and measuring the time required, the communication speed of the communication circuit connected to the user terminal concerned can be measured. According to the speed of the communication circuit, the distributable file size can be decided, and following this decision the specified advertisement data (video file, etc) from the advertisement data saving site can be obtained through the communication circuit and the appropriate interface. Access limitation function, for example, through user settings, can limit advertisements from adult content sites, or can limit use of the browser concerned on computers within companies. These filtering function include conventional methods, but in the future, every method that can be used to browse the web will be included.

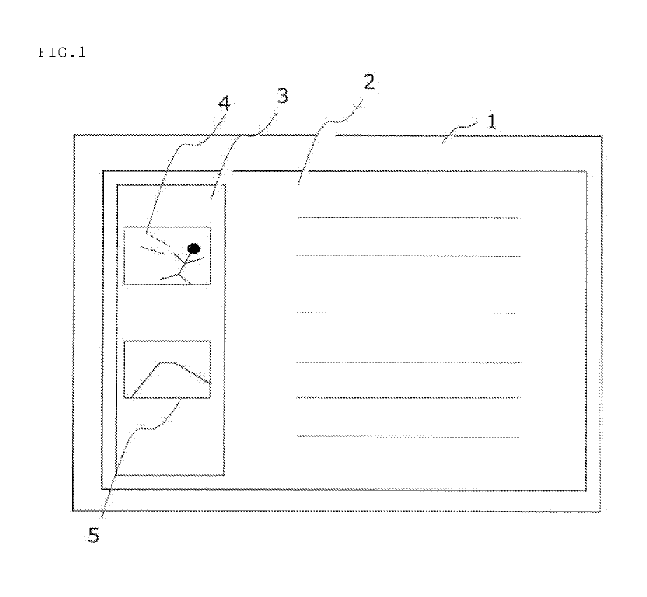

The advertisement display function is basically a function to display the advertisement data obtained from the advertisement obtaining function, and specific limitations do not apply as long as the advertisement can be transmitted to the user, but as shown in FIG. 1, one or more advertisements will be displayed in the advertisement display area set at one of the sides of the browsing page. The displayed advertisement includes video advertisements, image advertisements and text advertisements, but basically, it will be developed with a focus on video advertisements. In other words, a television-like video advertisement distribution function is built into the internet browser function.

The advertisement area can be switched between displayed/not displayed according to the user's selection. The proportion of the advertisement area in the entire screen can be set by the user, or a fixed proportion is also permitted. The advertisement in the advertisement area must in itself be readily visible, but at the same time must take into consideration not to obstruct visibility of the browsing page when browsing, and therefore, normally, the video advertisement should be limited to 1-2 frames with approximately 10-40%, or preferably 15-25% of the advertisement display area. For the same reason, image advertisements should be limited to 1-3 frames with approximately 5-60%, or preferably 10-40% of the advertisement display area. For text advertisements, there is not specific limitation. Yet, these numbers are tentative standards and therefore other proportions are also within the scope of the present invention.

If the browsing page scrolls vertically or horizontally, the browser display area can follow and move accordingly (the advertisement itself will be fixed), or a different advertisement can be displayed according to the scroll.

Generally, it is preferable that the advertisement display area does not overlap with the browsing page, but if it can be expected that the user would allow this, it can be displayed no the browsing page area as a float display, and the present invention includes such modes.

Each of the advertisements can be linked to the sponsors' websites, or for example, the advertisement can be changed to a different advertisement from the same sponsor every time it is clicked, or can be changed to an advertisement from a different sponsor. The timing for changing the advertisement can be limited to the transition time, or can be changed at fixed intervals.

Actions such as clicks are recorded by the advertisement management function, which will be explained later, and according to this, it becomes possible to give points or money as prescribed.

The advertisement display function can be a full screen display function. For example, as conventional screensavers are, when a designated length of time passes without input from the input unit (keyboard, mouse, touch panel, etc) of the computer, etc, video advertisements or slide advertisements are displayed. These can be switched upon the user's discretion and operation at any timing between full screen display and no display.

A typical pattern would be that according to the users' browsing history and the advertisement proposing requirements, a display would be shown on the desktop notifying the user that an advertisement is ready for the user, and when this is clicked, the advertisement display function of the browser of the invention (it can be the browser itself, or only the advertisement display function (a software monitor for watching video advertisements) will load, and the video advertisement will show in full screen mode. When the advertisement is finished, a link button (to sponsor websites, etc.) will show which includes determination of the point reward, which will be described later. When the link button is pressed, the points will be rewarded, and the user will jump to the sponsor page.

Be it display on the advertisement display area or full screen display, it is preferable to set, for example, a button for transition to the display page for detailed information, a button for transition to the purchase page, a close button (when the screen is clicked, the advertisement screen will immediately close).

Transition between display mode by advertisement display areas and the display mode by full screen display can be performed according to the user's mode of use. For example, if it can be determined from the input behavior to the computer that active browsing is taking place, the display mode by advertisement display area can be selected, but when there is not input for a designated length of time, screensaver display by full screen display can be selected. Video display can be an original function of the browser, or conventional methods of video display can also be used. The browser's plug-ins or third-party application, for example application software written in JavaScript or Flash, as well as Java (registered trademark) can be used.

Regarding the categorization method of display advertisements, by utilizing data based on the usage conditions of the browser as in conventional technologies, categorization matching the user can be included (explained later).

The advertisement management function is, basically, a function to record and analyze the results of the users' browsing behavior and/or searching history, a function to promote the obtaining of necessary advertisement data according to the advertisement obtaining function based on this data, and when giving incentive for advertisement browsing, includes at least one of the functions for saving the necessary data. The advertisement management function can be equipped on the web server, but all or part of the function can be equipped on the browser as well.

The function to record or analyze the users' browsing behavior and/or searching history is, for example, to analyze the users' preferences by recording the history of the site browsed and/or searched by the user. In the present invention, this function can be used only in the advertisement management function of the browser, and therefore the risks in terms of security and disclosure of personal information can be minimized. The function to record or analyze the users' browsing behavior and/or searching behavior, preferably, should be adjustable according to the users' preferences, and the analyzing function, as abovementioned, can be equipped on the website that saves the advertisement data. In this case, for example, the advertisement management function encrypt the recording of the history of the user's browsing site at each designated interval, and sends to management sites such as the website that saves the advertisement data.

This construction has the below effects. Search engines such as Google match the advertisements to display and the searched contents each time through the query inside the search engine site, and therefore, the power to match is not strong.

Attempts have been made at retargeting even after the user has left the search engine in order to improve matching, but because the connecting IP address changes each time, it is difficult to match by specifying the user.

On the other hand, according to the construction of the present invention as explained above, the entire query of the user including queries from other internet browsers is available, and it is substantially the same as obtaining queries from the operating system itself. Therefore, in combination with the users' browsing behavior, advertisements can be matched with greater accuracy.

The function to record or analyze the users' browsing behavior can be such that operates on a real time basis. For example, in the mode in which the advertisement display area is placed next to the users' browsing screen, according to the elements extracted from the browsed contents (for example, if the browsed screen is an article about automobiles, the theme would be “automobile”), the obtaining of advertisements according to the theme “automobile” will be specified by the advertisement obtaining function, and the necessary advertisement data will be obtained and displayed from the website (that saves the advertisement data). If the users' age, gender and other properties can be used, these properties will also be used for analysis.

The function to save necessary advertisement data is, literally, a function to save the advertisement data obtained according to the users' browsing behavior, etc. For example, through this, the same advertisement will be proposed to the user for a designated number of times without needlessly increasing traffic. This type of downloading of advertisement data can be performed on designated intervals, or can be performed when other tasks are not used on the computer or other user terminals.

For the present invention, it is preferable to give an incentive for advertisement browsing, etc. This type of incentive management is, for example, digitized by the number of clicks on the advertisement, length of advertisement display, etc, and at the designated timings, actualized by the function to sent do the site to manage the incentive. The incentive can be so-called points that can be used when purchasing designated products, etc, or can be a payment of cash and other real currencies. Or, it can be returned in the form of provider charges or circuit charges. These incentives did not exist in a steady manner in conventional video advertisements, and therefore could not distribute advertisements to users according to these properties. In the present invention, a strong incentive is given to the user to watch the video advertisement, the user will watch the video advertisement in a steady manner. As a result, the effectiveness of the advertisement will increase, the user profile can be refined, and the later described sales of advertisement space through bidding become possible.

Because the user always uses the browser, the browser in the present invention should preferably be equipped with a social function. Here, social function refers to the entirety of functions that actualize real time connections with other network users, for example all of the functions and elements of functions known today as social network services are included. For example, users' interaction systems in blogs, tweets, and platform functions for social applications are included. By combining these functions with the browser, the user can use these functions without distinguishing with browser use and advertisement browsing. Specifically, by setting a button for tweets and social application in the screen composition, these functions can be used seamlessly with the browser. A mechanism in which an incentive will be given for the diffusion of the browser itself, in synchronization with the social function, can be included. For example, the users' “friends” or acquaintances from the social function can be extracted, and the point rewards mentioned below will be given for the introduction or bringing in of new users.

### Embodiment 2

According to the second embodiment of the present invention, the advertisement system that uses the browser as described in Embodiment 1 will be provided. This is system is 1) one or more of the advertisement data saving site placed on the communication network and 2) including the user terminal equipped with the browser as described in Embodiment 1 and connected to the abovementioned communication network, a system to display to the user, using the abovementioned advertisement display function and following the data obtained by the abovementioned advertisement management system through the advertisement obtaining function of the above-mentioned browser.

The composition of the advertisement data saving site is usually not limited as long as it can be used, but typically is the site or group of sites that hold the advertisement database that includes the advertisement information that is actually displayed, along with the advertisement data management file group including the advertisement file that describes the properties of the advertisement to be displayed (keywords, tags, etc), and is normally composed of multiple servers. The advertisement obtaining function of the abovementioned browser, according to the users' browsing behavior, obtains advertisements that match the keyword by sending to the advertisement saving site the keywords, etc (user information) that seem to be of interest to the user.

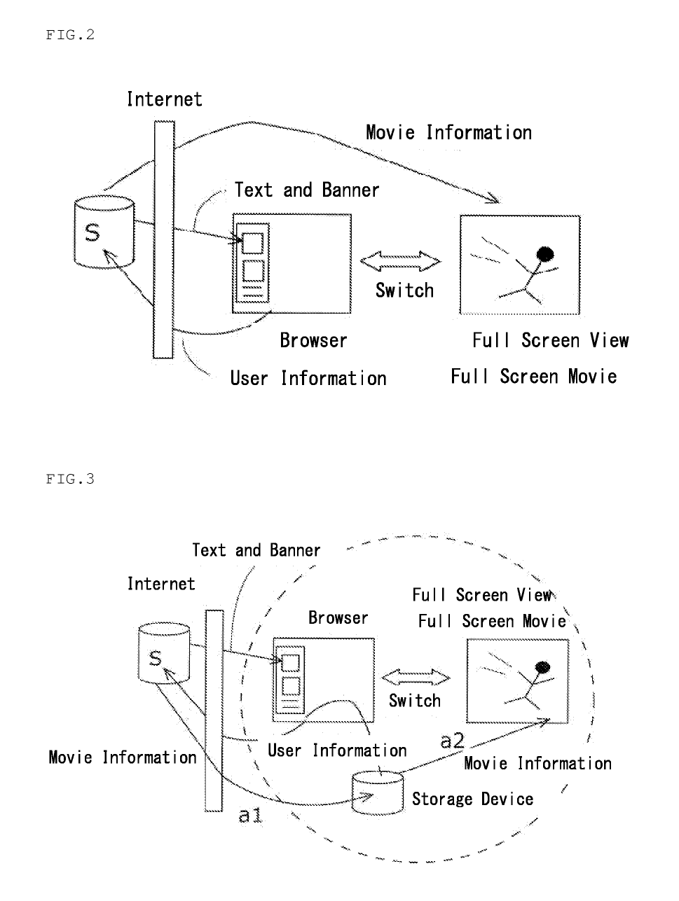

FIG. 2 shows the relationship between the server S of the advertisement data saving site and the two modes of display (“browsing page+display of the advertisement area” and “full screen display) of the browser that are slightly different from the mode described in Embodiment 1.

In this mode, when “browsing page+display of the advertisement area” is selected “text and banner” advertisement data is send to the browser through the internet from server S, and when “full screen display” is selected, the video advertisement data is sent to the browser through the internet. In both cases, user information is sent from the browser. Switching between these display modes can be operated by the user, or can be switched from the former to the latter after a designated length of time.

FIG. 3 shows the relationship between server S of the advertisement data saving site and the two modes of display (“browsing page+display of the advertisement area” and “full screen display”) of the browser that are slightly different from the mode described in Embodiment 1.

In this mode, when “browsing page+display of the advertisement area” is selected, it is the same at the point of sending “text and banner” advertisement data is sent through the internet from server S to the browser, but the video advertisement data will be downloaded to the storage device of the users' computer or terminal through the internet from the browser (a1 in the drawing; the dotted lines in the drawing approximately show the computer or user terminal range). The downloaded the video information will be sent (a2 in the drawing) to the browser according to the “user information” from the browser, and played.

User information is sent to server S from the storage device through the browser, or sent directly from the browser to server S through the internet.

The advertisement data saved in the storage device is not constant, and is renewed on the advertisement data newly added to the server based on user information through the browser through the internet.

Switching between these display modes can be operated by the user, or can be switched from the former to the latter after a designated length of time.

Or, profiling can be performed through the use of conventional profiling methods, and advertisements can be obtained in accordance with this. For example, a clustering algorithm can be used in order to find profiles similar to the user profile. These methods are published in various patents or academic papers, and for clustering algorithms, for example, a method such as the one described in Patent Application Publication No. 2003-529127 can be used.

Properties of the advertisement include keywords, tags, display size, display format, advertisement format, etc. For example, it includes for each advertisement the display size of the advertisement (horizontal and vertical dimensions of the advertisement screen), advertisement format (text, image, animation, etc, but especially video advertisements), display timing (intervals for displaying advertisements on the web browser), advertisement information (content and expiration date of the advertisement based on the format), and the advertisement obtaining unit of the browser can obtain advertisement information by designating the display size, display format, advertisement format, display timing and keywords as conditions for obtaining when obtaining of advertisements is necessary.

The system of the present invention includes one or more management sites on the communication network, and the abovementioned browser's advertisement management function saves and/or analyzes the users' advertisement browsing data, sends the data or the analyzed results to the management site, and according to this, gives advertisement browsing rewards to the user. The reward for the advertisement browsing can be decided among per click, per browsing time, per each completed viewing. The sponsor can also choose a setting that maximizes the GRP (gross rating point).

Generally, GRP (gross rating point) is the total carry-over factor of television advertisements, and can be calculated by the product of the audience rating for each time period and the number of times the commercial was distributed. The total carry-over factor is an index often used as an approximate standard for advertisement delivery. Yet, for internet advertisement, the audience rating for each time period does not hold a significant meaning. Therefore, for example, a reward setting method in which the product of proximity between the user profile and the target user profile, and the cumulated number of views for the advertisement is maximized.

For example, for a cosmetics item for which the target user is the so-called F1 layer (females from age 20-34), if an individual from the M3 layer (males over age 50) click the advertisement many times or watch for a long period of time, in general the advertisement outcome would be low. Therefore, in this case, for the F1 layer profile, the proximity with the target user profile (referred to “proximity” herein after for convenience) can be defined as 1, while the proximity for the M3 layer can be set at an appropriate value less than 1 (for example, 0.3), categorization can take place, and the advertisement can be distributed to target layers that have a proximity close to 1 in the advertisement obtaining function, as well as related the reward for the browsing with the proximity (for example, in this case, an individual from the M3 layer watching would be limited to 0.3 times that of an individual from the F1 layer watching). Through this, even if both a female from the F1 layer and a male from the M3 layer watch the same advertisement for the same length of time, the reward given to the latter can be limited to 0.3 times that of the former, and the waste of advertisement rewards can be mitigated.

For advertisements that are designated for the subject, the value varies also for the sponsor side. Therefore, for the system in the present invention, advertisement space (in the present invention, advertisement spaces can exist in infinite amounts) should preferably be purchased in a bidding system by sponsors. In other words, it is a system in which the purchasing cost for the advertisement distribution fluctuates according to the target user profile. For example, according to some property (for example, gender, age, profession, hobby, etc) of an imaginary subject or a keyword, a bidding will take place, and prioritized distribution to a layer that can be expected to react to that property (for example, gender, age, profession, hobby, etc) or keyword would take place.

In advertisement, systems such as Adwords where the price determination for keywords are performed through bidding already exist, but such system is not known for video distribution advertisements. Yet, the specific bidding system is that same as PPC (pay per click) services like Adwords, and the methods used in these systems can be used for the present invention (PPW (pay per watch), so to speak).

The intention, in straightforward terms, actualizes a television-like function of distributing video advertisements in the function of an internet browser. That is, the present invention provides a function that is different (connecting to an original advertisement distribution server) from (but operates together with) the conventional function of browsers. Additionally, the present invention is equipped with a social function and is a browser that would be used constantly by the user, and can accept various flows of information. Due to this, through selection of advertisements, the user profile can be refined, and therefore it is a highly valuable system for advertisement media.

1. An internet browser equipped in itself with a function to obtain and display video advertisement data.

2. The internet browser according to claim 1 comprising an internet browser program to which base an advertisement obtaining function and/or advertisement display function is/are appended.

3. The internet browser according to claim 1 further equipped with social functions.

4. The internet browser according to claim 1, further equipped with an advertisement management function, wherein the advertisement management function can save and/or analyze users' browsing history and/or searching history, select recommended advertisements according to these results, transmit to the advertisement obtaining function, the advertisement obtaining function obtains advertisement data accordingly, and the advertisement display function either displays the advertisement in the advertisement display area or the entire screen.

5. The internet browser according to claim 1 wherein the browser obtains data from a website equipped with an advertisement management function which can save and/or analyze users' browsing history and/or searching history, select recommended advertisements according to these results, and using or not using the advertisement management function of the browser, displays the advertisement in either the advertisement display area or the entire screen.

6. An advertisement system that is connected to one or more advertisement data storing websites located on a communication network and the communication network itself, includes the user terminal equipped with the browser as set forth in claim 1, and displays to the user data obtained from the browser, according to the advertise management function.

7. An advertisement system according to claim 6 comprising an advertisement data storing website equipped with an advertisement information database which includes advertisement data management file groups including advertisement file that describes the properties of the advertisement to be displayed and advertisement information actually displayed wherein the system sends to the browser the advertisements that the user can be considered to be interested in based on the data sent from the advertisement obtaining function of the browser.

8. The advertisement system according to claim 6 wherein video advertisements from the advertisement data storing website are downloaded and saved in the user terminal and played according to requests to the controllers (including storage devices) from the browser.

9. The advertisement system according to claim 6 further comprising one or more management websites located on the communication network, wherein the browser management function saves and/or analyzes the users' advertisement browsing data and transmit the data or analyzed results to the management website and a reward is given to the user for watching the advertisement according to the data or analyzed results.

10. An advertisement system according to claim 6 further comprising one or more management websites located on the communication network, wherein the browser management function saves and/or analyzes the users' advertisement browsing data and transmit the data or analyzed results to the management website and a reward is given to the user for watching the advertisement according to the data or analyzed results

11. The advertisement system according to any of claim 6 in which the reward given to the user for watching an advertisement is related to the profile of the target layer and the profile of the user.

12. The advertisement system according to claim 6 in which the advertisement space is purchased by advertisement providers through bidding.
